(19) United States
(12) Patent Application Publication
(10) Pub. No.: US 2018/0229713 A1
(43) Pub. Date: Aug. 16, 2018

(54) RANGE EXTENDER FOR INDUSTRIAL ELECTRIC VEHICLE

(71) Applicant: Motrec International Inc., Sherbrooke (CA)

(72) Inventors: Jocelyn Gagnon, Sherbrooke (CA); Martin BEAUMONT, Sherbrooke (CA); Éric BARIL, Sherbrooke (CA); Pierre-Luc LAPOINTE, St-Hippolyte (CA); Hugo NORMAND, JR., Laval (CA); Joël FECTEAU, Québec (CA); Paul-André DROUIN, Neuville (CA); Rémy BÉLAND, Québec (CA); Tony GUAY, Québec (CA)

(21) Appl. No.: 15/893,071

(22) Filed: Feb. 9, 2018

Related U.S. Application Data
(60) Provisional application No. 62/457,318, filed on Feb. 10, 2017.

(30) Foreign Application Priority Data
Feb. 10, 2017 (CA) 2957693

(51) Int. Cl. B60W 20/13; B60W 10/08; B60W 10/06; B60L 11/02; B60L 11/18; G06N 7/02

(52) U.S. Cl. CPC B60W 20/13; B60W 10/08; B60W 10/06; B60L 11/02; B60L 2260/48; B60L 11/1862; G06N 7/02; B60W 2510/244; B60W 2710/0644; B60L 11/1814

(57) ABSTRACT

A series-hybrid powertrain includes a range extender, a battery, an electric motor and a controller. The range extender may include an internal combustion engine and a generator. The powertrain has three modes of operation. In electric only mode, the battery powers the motor and the range extender is not allowed to operate. In forced charge mode, the range extender attempts to power the drive motor and also re-charge the battery if the battery is discharged to, or is found below, a specified charge. In hybrid mode, the range extender is operated by a controller that determines the output of the range extender in hybrid mode considering inputs that relate to the state of charge of the battery and the power consumption of the electric motor. Optionally, the controller uses fuzzy logic to determine the output of the range extender. The powertrain may be used in an industrial vehicle.

### CROSS-REFERENCE TO RELATED APPLICATIONS

This application is a non-provisional application of U.S. Application Ser. No. 62/457,318, filed Feb. 10, 2017, which is incorporated by reference.

### FIELD

This specification relates to hybrid powertrains, for example series hybrid powertrains, and to industrial vehicles.

### BACKGROUND

Hybrid powertrains have been used in automobiles, trains and airplanes. In a series hybrid, alternatively called a range extended electric vehicle or a plug-in hybrid electric vehicle, the vehicle is driven by an electric motor coupled to a battery. A range extender, which can include an internal combustion engine and a generator, is available to recharge the battery if necessary, and thereby extend the range of the vehicle. In most cases, mechanical energy from the internal combustion engine does not move the vehicle directly.

In one control strategy for a series hybrid, the vehicle uses battery power alone until the battery reaches a nearly discharged state, for example 8% of its maximum charge. At that point, the internal combustion engine is started and operated at its maximum or most efficient power to keep the battery from being completely discharged while the vehicle continues to operate. This strategy seeks to maximize the use of plug-in electric power.

### INTRODUCTION

Industrial vehicles are vehicles that operate within an industrial site, for example a factory or a warehouse. Industrial vehicles include, for example, tow tractors, personnel carriers, trams, burden carriers, stock chasers and other utility or material handling vehicles. These vehicles may be powered by either electric motors or internal combustion motors. An industrial vehicle may operate indoors, outdoors, or both indoors and outdoors.

This specification describes a series hybrid powertrain, an industrial vehicle having a series hybrid power train, and methods of operating them. The powertrain includes a range extender, a battery, an electric motor and a controller. Optionally, the range extender may include an internal combustion engine and a generator. Optionally, the electric motor and the generator may be AC devices controlled through associated inverters and connected through a common bus to the battery. The controller may allow multiple modes of operation. The controller may use a fuzzy logic based control method in at least some circumstances. The industrial vehicle can be used, for example, in applications when an internal combustion engine is currently favored over a battery-powered vehicle. In some of these applications, electricity is not available throughout the site or the duty cycle of the vehicle does not reliably provide sufficient recharge time.

In an example, the powertrain has multiple modes of operation that can be selected by a vehicle operator. In an electric only mode, the battery powers the motor and the range extender is not allowed to operate. In this mode, the vehicle can be used in buildings that do not permit internal combustion engines indoors. In a sustained charge mode, alternatively called a forced charge mode, the range extender attempts to power the drive motor while also keeping the battery at least nearly recharged, for example at 75% or more of a full charge. This mode can be used, for example, to prepare a vehicle operating outdoors to switch to electric only mode. In a hybrid mode, the range extender is operated by a controller that determines the output of the range extender considering inputs that relate to the state of charge of the battery and the power consumption of the electric motor. Optionally, the controller uses fuzzy logic to determine the output of the range extender.

In an example of the hybrid mode, a system or method seeks to avoid large currents flowing to or from the battery. For example, when the electric motor is drawing a significant amount of power, for example over a threshold such as 50% of its maximum power, the range extender operates even if the battery is moderately, for example up to a threshold of 80% or more, charged. Optionally, the amount of power delivered by the range extender in this example can generally increase with decreasing battery state of charge. For further example, when the battery is at or below a selected minimum charge, for example at least 20% or 25% charged, the range extender operates regardless of the power drawn by the electric motor. Optionally, the amount of power delivered by the range extender in this further example can generally increase with increasing power drawn by the motor. At other times, for example when the motor is drawing less than a threshold such as 40% of its maximum power and the battery is above a threshold such as 40% of charge, the range extender does not operate. In this way, the range extender provides power selectively such that the battery discharges over time but the current flowing into or out of the battery is tempered. This helps extend the useful life of the battery, which can be a key factor in the economical operation of an industrial vehicle.

This specification describes a fuzzy logic control method that includes categorizing variables including the power drawn by a motor and the state of charge of a battery connected to the motor, each into multiple classes. The degree of membership of the variable in each class is determined using a membership function that maps the variable to a truth value in a predefined range, for example between 0 and 1. The control method applies a plurality of rules that consider the degrees of membership of each variable in its corresponding classes. The control method further includes considering the result of a plurality of the rules to determine the output of the range extender.

The article “Design and control of a range extender for small industrial vehicles” and corresponding presentation at the EVS29 Symposium held in Montreal, Quebec, Canada on Jun. 19-22, 2016 are incorporated herein by reference.

This specification further describes a system adapted to control a vehicle using the fuzzy logic control method. The system includes a controller operably connected to a range extender, a sensor associated with a motor, and a sensor or state of charge indicator associated with a battery. The sensor associated with the motor may be an ammeter. The sensor associated with the battery may be a voltmeter. The controller may be configured to implement the fuzzy logic control method. The controller is optionally configured to also calculate a state of charge of the battery. In an example, the controller receives input values related to current drawn by the motor and the voltage of the battery and determines an amount of power or current to be produced by the range extender.

### BRIEF DESCRIPTION OF THE FIGURES

FIG. 1 is a schematic drawing of a hybrid powertrain.

FIG. 2 is a drawing of an exemplary industrial vehicle.

FIG. 3 is a state flow diagram showing a state of charge calculation.

FIG. 4 is a diagram showing an example of battery state of charge during operation in an internal combustion mode.

FIG. 5 is a drawing of a fuzzy logic input membership function for traction motor current.

FIG. 6 is a drawing of a fuzzy logic input membership function for battery state of charge.

FIG. 7 is a fuzzy logic output membership function for range extender current.

FIG. 8 is an exemplary plot of range extender current as a function of traction motor current and battery state of charge for operation in a hybrid mode.

### DETAILED DESCRIPTION

In general, a hybrid powertrain includes a battery, an electric drive motor, a range extender and a controller. In the examples described herein, the range extender uses an internal combustion engine (ICE) coupled with an alternating current (AC) motor functioning as a generator, in turn coupled with an inverter or rectifier to provide direct current (DC) power. The DC power can be supplied to one or both of the battery and drive motor. The drive motor is connected to the wheels of a vehicle. Optionally, the drive motor is an AC motor coupled with an inverter so as to operate from supplied DC power. The controller operates according to a program, for example a program having a set of fuzzy logic rules, and produces output signals that are sent to the range extender. The output signals cause the ICE to start and stop and cause the ICE to produce current in amounts determined by the controller.

Optionally, the controller is a fuzzy logic controller. The fuzzy logic controller is programmed to select a current, for example at the output of the range extender, as a function of the power drawn by the electric motor and the state of charge of the batteries, optionally among other inputs. The controller first classifies the input values according to a membership function, for example, the battery state of charge can be low, medium or high. The membership function values are then evaluated according to a rule set to find a corresponding output function. Changing either the shape of the membership functions or the rule set modifies the range extender's behavior.

Alternatively, the controller may use another form of control. For example, the controller may be an optimization-based controller adapted to maximize or minimize one or more parameters based on a model, past experience and/or sensors. In the case of an industrial vehicle, the optimization could be based on total cost of operation, including gasoline consumption, metered electricity consumption and equipment replacement. One optimization technique, dynamic programming, calculates required inputs from a predetermined driving cycle. However, while some industrial vehicles operate according to a predetermined cycle, most do not. The driving cycle of an industrial vehicle also varies from one customer to another. Another optimization technique, the artificial neural network method, would allow a program to update its behavior based on past experience. However, training sets typically used in machine learning systems do not exist for most industrial vehicle applications. Further, one type of vehicle may have many different applications each of which might require a different training set.

For industrial vehicles, equipment replacement cost is dominated by battery replacement cost, and battery replacement cost may also dominate the total cost of operation. While the vehicle is operating in a hybrid mode, the fuzzy logic controller can allow plug in electricity to be used while attempting to avoid high battery discharge and charging rates. In this way, a fuzzy logic controller can provide nearly optimized control for an industrial vehicle. However, a fuzzy logic controller may be pre-programmed and yet optionally tuned for a specific user. Accordingly, the inventors prefer a fuzzy logic controller.

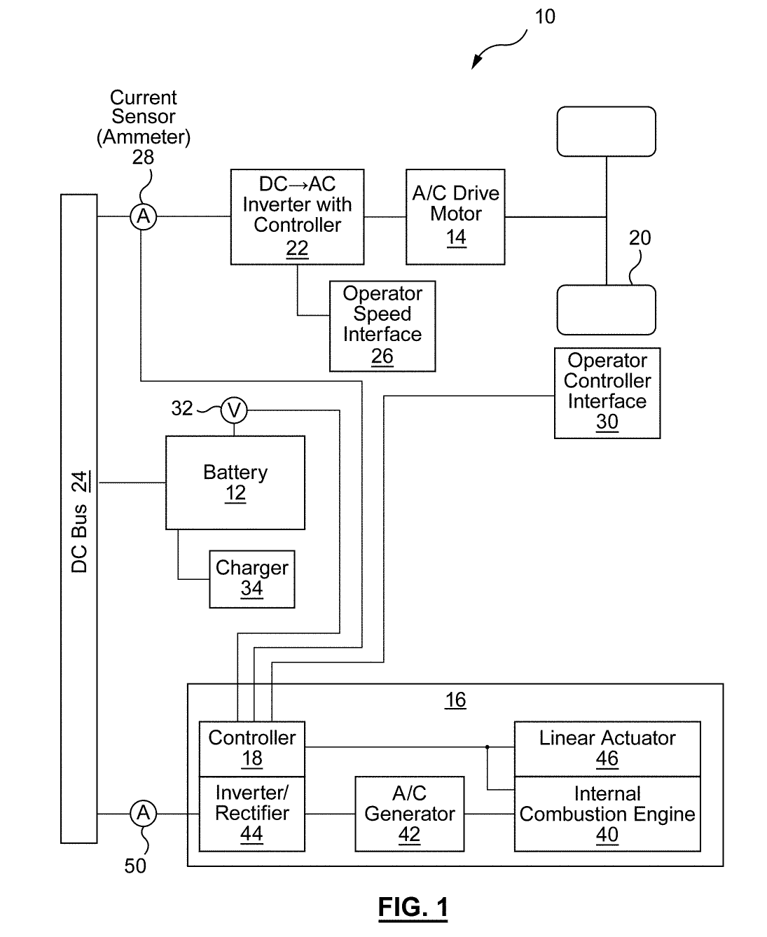

FIG. 1 shows a hybrid powertrain 10. The powertrain 10 has a battery 12, a drive motor 14, a range extender 16 and a controller 18. The controller 18 may be, for example, a programmed general-purpose computer or a programmable logic controller. The controller 18 in the example shown is built into the range extender 16, in particular into a second inverter 44. This helps in making a range extender 16 that is a more nearly freestanding unit easily added to an existing electric only vehicle. Optionally, the controller 18 may be a separate component. In another option, a separate controller 18 also replaces the controller built into the inverter 22 and the operator speed interface 26 is connected to controller 18.

The drive motor 14 is connected to the wheels 20 of a vehicle. The drive motor 14 may be an AC or a DC motor. In the example of FIG. 1, the drive motor 14 is an AC motor that receives power from a DC bus 24 through an inverter 22 having an integrated motor speed controller. A driver controls the speed of the vehicle through a foot peddle or hand lever connected to a speed control interface 26. The speed control interface 26 converts the driver's input into a signal that is sent to the motor speed controller within the inverter 22. An ammeter 28 located between the DC bus 24 and the drive motor 14 sends a signal related to the power drawn by the drive motor 14 to controller 18. Although the powertrain 10 uses an AC drive motor 14 and inverter 22, optionally a DC motor and speed controller could be used.

The driver operates controller 18 through a controller interface 30. The controller interface 30 may appear, for example, as a board with one or more button, switches or knobs, or as a touch screen. The controller interface 30 allows the driver to, for example, turn the powertrain on or off, and select between an electric, hybrid or forced charge mode of operation.

The battery 12 is typically made up of many smaller batteries wired together. The battery 12 is connected to the DC bus 12. A voltmeter 32 determines the voltage of the battery and sends a signal to the controller 18. Optionally, the voltmeter 32 is built into controller 18. The controller 18 uses the voltage readings, optionally among other inputs, to determine the state of charge of the battery 12. Alternatively, the controller 18 may be connected to a state of charge indicator connected to the battery. A plug in charger 34 is available to recharge the battery 12 when the vehicle is off duty.

The range extender 16 shown has an internal combustion engine (ICE) 40, an AC generator 42 and a second inverter 44, alternatively called rectifier 44. Optionally, the generator 42 may be the same as the drive motor 14 and the second inverter 44 may be the same as inverter 22. Alternatively, a range extender could use a DC generator.

The controller 18 is connected to an electrical switch of the ICE 40 so as to shut down the ICE 40 by disabling its ignition system, or to re-enable its ignition system. To restart the ICE 40 while its ignition system is enabled, the controller 18 causes second inverter 44 to draw power from DC bus 24 and produce an AC signal to rotate the generator 42. The generator 42 is coupled to the drive shaft of the ICE 40. Rotating the generator 42 causes the generator 42 to act as a starter motor to turn and restart ICE 40.

The ICE 40 has an integrated governor to reduce engine speed (rpm) when the ICE 40 is unloaded and to otherwise maintain a generally constant speed over a range of loadings. The governor has a mechanical, centrifugal force based, feedback mechanism. When the ICE 40 rotates faster than the target speed, a force is applied to the throttle linkage to restrict air flow and slow down the ICE 40. Conversely, when the ICE 40 rotates below the target speed, a spring applies a force to the throttle linkage to speed up the ICE 40. In this example, the throttle linkage is connected to butterfly valve in a carburetor if the ICE 40 but alternative arrangements are available to produce the same effect in fuel injected or electronically controlled engines.

Although an ICE based generator set (also called a “gen-set”) typically has only one target ICE engine speed, for example a speed that is deemed optimal when producing the rated full continuous power of the gen-set, the range extender 16 is frequently required to produce only a moderate current to avoid a large net (i.e. charging) current being sent to battery 12. To help the range extender 16 operate at moderate current output, an actuator 46, for example an electromagnetic linear actuator, is coupled to the ICE 40 and operable by the controller 18. The actuator 46 applies a force to the ICE 40 governor mechanism, for example by biasing the spring, to adjust the target ICE 40 engine speed. Alternative arrangements could produce the same effect in a fuel injected or electronically controlled engine.

Based on the required range extender 16 output current, the controller 18 selects one of 2 or more predetermined settings for the actuator 46. For example, the controller 18 may apply a look up table or other method that maps bands of range extender output current 16 to a discrete set of actuator 46 settings. Optionally, the controller 18 could be allowed to apply linear or proportional control and move the actuator 46 to any setting in its operating range. However, this is not preferred since it is not intended for the controller 18 to attempt to make fine adjustments of range extender 16 output by ICE 40 throttle modulation. Instead, the governor is allowed to control ICE 40 in response to changes in loading on it. The controller 18 manipulates the second inverter 44 to control the voltage and/or current output of the range extender 16. The controller 18 uses a second ammeter 50 between the DC bus 24 and the second inverter 44, for example in a feedback loop, to regulate the output current sent from the second inverter 44 to the DC bus 24. The linear actuator 46 is used to provide one or more alternative ICE 40 engine speeds that allow the ICE 40 to work better when the required range extender 16 output is materially different than its rated full continuous. Optionally, if an ICE without a governor is used, or if another type of engine such as a diesel engine is used, the actuator 46 can be used to provide direct throttle modulation corresponding to the desired output of the range extender 16.

Comparing second ammeter 50 to ammeter 28 allows the current flowing into or out of the battery to be calculated. Optionally, an ammeter can be provided between the DC bus 24 and the battery 12.

When the driver selects electric mode, the controller 18 shuts down the ICE 40 if it is running and does not turn the range extender 16 on. The drive motor 14 draws power from the battery 12 according to the driver's inputs to the operator speed interface 26. When the driver selects a forced charge mode, the controller 18 starts the ICE 40 if the battery 12 is below a specified state of charge and begins recharging the battery 12 at a predetermined rate regardless of whether the vehicle is moving or not. The predetermined rate is preferably a moderate rate, for example within 25% of the charge rate provided by the plug in charger 34, or less than 25% of the maximum charge rate of the battery 12. The recharging rate is provided in addition to any current drawn by the drive motor 14. Once a specified upper state of charge is reached the ICE 40 is turned off if the vehicle is moving. The vehicle may continue to be driven using power from battery 12. The ICE 40 is restarted, and charging continues, when a specified lower state of charge is reached. If the vehicle is stopped, the range extender 16 may continue to operate even if the upper state of charge is reached in order to balance multiple batteries within battery 12.

When the driver selects hybrid mode, the controller 18 poles a signal from ammeter 28 and its calculated state of charge, or alternatively a signal from voltmeter 32 as a direct indicator of state of charge. The controller uses a fuzzy logic based method to determine the current required from range extender 16. This method includes using a membership function, for each of the current and state of charge, to determine the degree of membership of the polled value in each of multiple possible classes. The membership function maps the polled value to a truth value in a predefined range. The range has a minimum value, for example 0, signifying no value and a maximum value, for example 1, signifying full membership. The method further includes applying a plurality of rules that utilize the degrees of membership of each polled value in the corresponding class used in each rule. The results of the rules are then considered to determine the required current to be supplied from the range extender 16 to the DC bus 24.

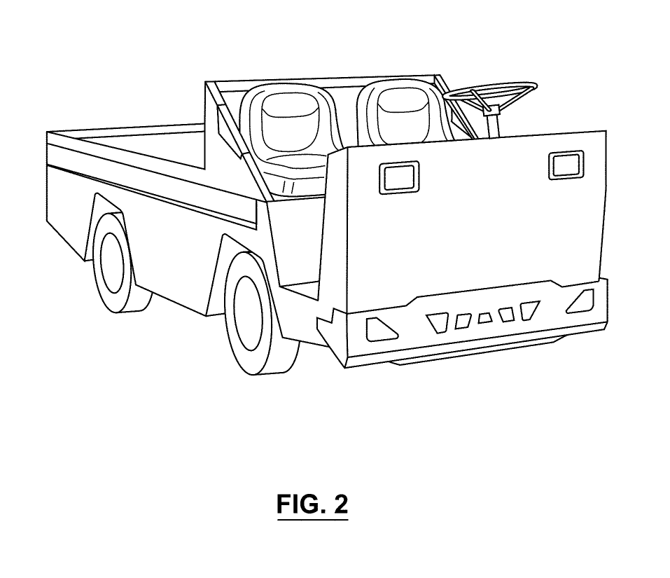

An exemplary vehicle having a hybrid powertrain was made based on an industrial burden (load) carrier. The vehicle in particular is an MC-480 produced by Motrec, shown in FIG. 2. This vehicle is driven with an electric drive motor but the motor is normally powered by a battery only with a nominal 48 V electric system. The vehicle can hold up to two people, carry a load of up to 3000 pounds (1361 kg) or tow up to 6000 pounds (2722 kg). Its maximum speed is 10 mph (16 km/h).

An MC-480 vehicle was monitored under use to measure its mean energy consumption, which was 6 kW. The lead acid battery operates in a range of 45V to 55V. The battery may be charged at between 20 A and 120 A. However, a typical plug in recharger has a charging rate of 25 A.

An internal combustion engine was added to the vehicle. The engine was a Subaru EX40. This engine is an air-cooled, 4-cycle, gasoline powered engine. Its rated continuous power is approximately 6.3 kW at 3000 RPM, which exceeds the mean energy consumption of the electric traction motor.

A generator was coupled directly to the drive shaft of the ICE to form the range extender. The generator is an air-cooled AC motor made by Advanced Motors & Drives, model ACX-3164. This is the same motor used as the traction motor in the vehicle. The generator is able to provide up to 6.9 kW at 3200 RPM. The generator is coupled to a rectifier, in particular a Schwarzmüller M104-S-48/300-P inverter. This inverter is equipped with a PLUS+1 controller from Sauer Danfoss. This controller, though embedded in the range extender, was used as the primary controller (i.e. analogous to controller 18 in FIG. 1) of the powertrain.

Industrial vehicles can be fitted with many different battery packs. These packs come in a range of voltage, capacity and chemistry. Most of the vehicles come equipped with a simple state of charge (SOC) indicator that is updated during discharge but is only updated in charge when an on-board charger is plugged in. The existing SOC indicator therefore does not indicate when the range extender charges the batteries. A state of charge calculation was therefore implemented in the range extender controller.

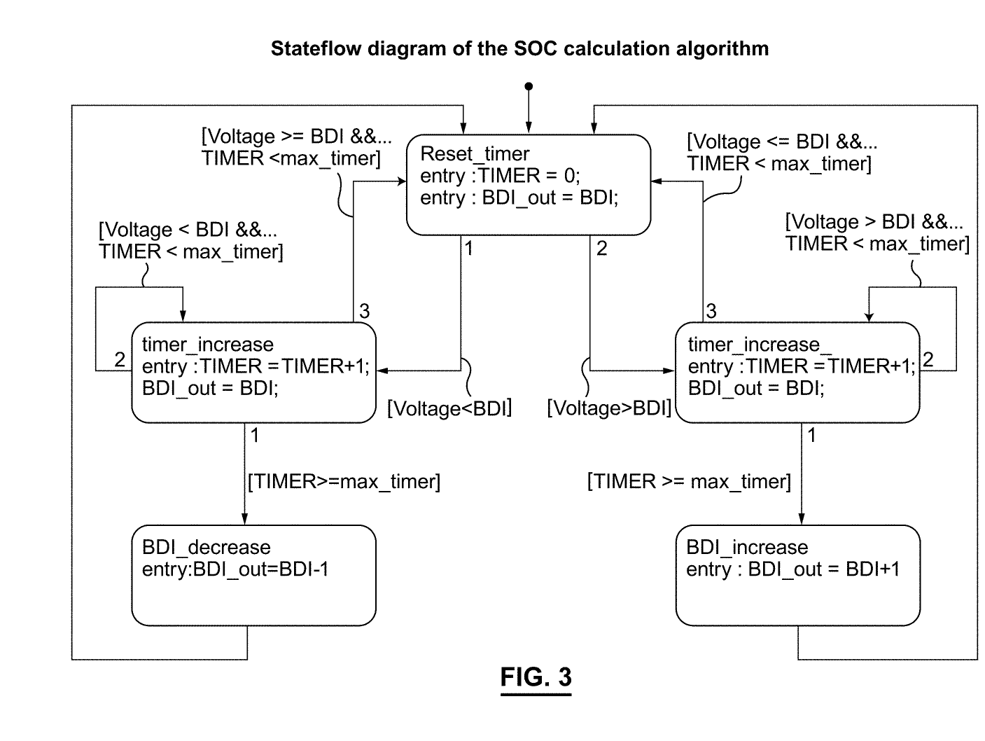

The SOC calculation algorithm compares the measured voltage to tabulated data relating voltage ranges to a whole number indicating state of charge. State of charge is updated periodically according to a preselected, but adjustable, period of time. If the measured voltage drops below the voltage range for a given SOC assigned at the start of a period of time, the SOC is reduced by 1 for the next period of time and a timer is reset. Conversely, if the measured voltage exceeds the appropriate voltage range during a period of time, the SOC value is increased by 1 for the next period of time. FIG. 3 is a stateflow diagram showing the state of charge calculation algorithm. In this diagram, the BDI variable is equal to the tabulated voltage value.

This algorithm was chosen over coulomb counting for the SOC calculation since the coulomb counting method causes errors when used in lead-acid battery systems. ANN and Khalman filtering were not used because both require extensive tuning for different systems. However, the algorithm described herein might not work with Li-Ion batteries having LFP chemistry due to their relatively flat voltage to SOC curves. However, this type of battery is not currently used in many industrial vehicles since weight and extreme range are not typically critical.

The driver can select between electric only, hybrid and forced charge modes from a controller interface on the dashboard of the vehicle. In electric only mode, the vehicle works as a battery electric vehicle. The ICE engine is not permitted to turn on as if there is no range extender. This mode is used, for example, when the vehicle is working indoors. This mode may alternatively be called a charge depleting mode. However, it differs from the charge depleting operation of a hybrid automobile in that it is a state mandated by the operator not a function of the battery having a state of charge above a specified minimum.

Forced charge mode, in practice, often causes the vehicle to work essentially as an ICE powered vehicle while also recharging the batteries if they have been discharged. This mode can be used, for example, to prepare a vehicle operating outdoors to be used indoors. In this mode, the range extender provides the current drawn by the drive motor and also an excess current used to keeping the batteries generally charged. This mode can also be called a charge-sustaining mode or internal combustion mode.

In this example, the range extender is controlled in internal combustion mode by a simple rule set programmed into the controller. The engine will start if the SOC is below a minimum, for example 75% or more or 85% and, if the vehicle is moving, will stop if the SOC is higher than a maximum, for example 95%. The gap between the upper and lower threshold may be chosen, at least in part, to avoid turning the ICE 40 on and off very frequently, which can cerate excessive wear on the mechanical components and also annoy the vehicle driver.

If the vehicle is standing-by in forced charge mode, the range extender will try to finish the charge by changing from a specified current mode to specified voltage mode. The ICE will stop when the current provided in specified voltage mode drops below a set value, for example 2 or 3 A. This transition to a specified voltage charge allows the batteries to equalize from time to time even if the vehicle does not use the on-board charger for a long period of time. The range extender's output current in specified current mode is selected by adding the measured current consumption from the drive motor to a constant value. This constant value may be equivalent to the capacity of the on-board charger, or within 25% of that value, or up to 25% of a maximum charging rate. Accordingly, even if the vehicle is moving around and consuming energy at up to a moderate rate, the range extender should be able to charge the batteries as if it was standing still and using the on-board charger. However, if the vehicle is standing still or moving using only a small amount of power, the charging rate is not large.

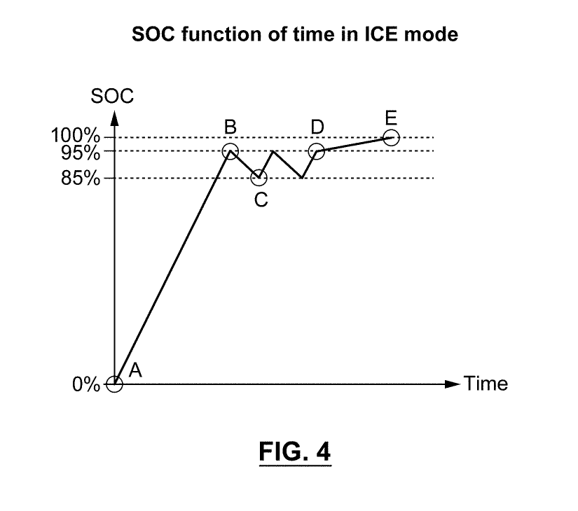

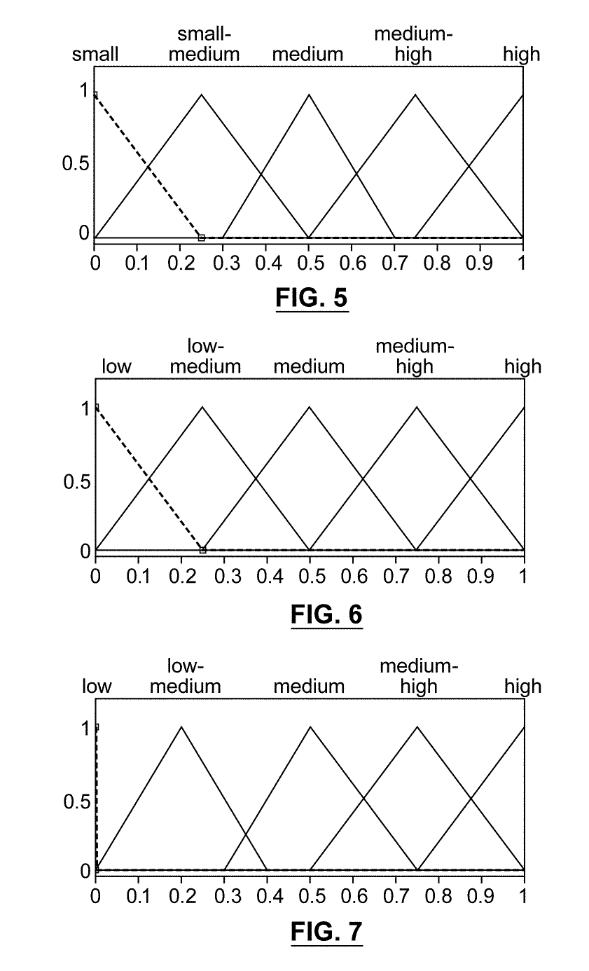

FIG. 4 shows an example of the SOC variations as a function of time in forced charge mode. A point A, the battery is discharged when the vehicle is switched into internal combustion mode. The ICE will start and provide a net current of, as an example, 25 A to the battery. At point B, the battery reaches 95% SOC and the vehicle is moving. The ICE will stop until the SOC drops to point C. At this point, the ICE will restart and resume charging. At point D, the vehicle has reached 95% SOC but is not moving, allowing the range extender to switch into constant voltage mode and finish the charge. At point E, the battery is fully charged, the charging current is below the threshold value and the range extender will shut off until the vehicle moves again.

The 10 powertrain includes (not shown) a “start” button, switch or other device that can be used to selectively disable the powertrain 10 or re-enable the powertrain into a standby mode. The start device may, for example, selectively disconnect the inverter 22 and optionally also the range extender 16 from the DC bus 24 or connect the inverter 22 and the range extender 16, if disconnected, to the DC bus 24. When the start device is activated, one of the modes may be a default mode, selected initially by starting the powertrain and not making any other selection. The hybrid or electric only mode may be the default mode of the range extender. The hybrid mode is the preferred default mode unless the vehicle is mostly used indoors, in which case the electric only mode may be the preferred default mode. Alternatively, there may be no default mode and the operator must select a mode before the powertrain 10 will respond to inputs from the operator speed interface 26.

The control algorithm for the hybrid mode is based on fuzzy logic. In this mode, although the ICE engine may run at some times even while the battery is not discharged, the rules applied by the controller typically allow the battery to discharge over time. This reduces fuel consumption by consuming plug in electricity. However, other rules dominate when the SOC reaches a value, optionally in the range of 20%-30%, or approximately 25%. When this SOC is reached, the rules applied by the controller tend to keep the SOC around this level until the vehicle is plugged-in to a power outlet and recharges the batteries through the on-board charger. The low charge value is higher than the low charge value used in some other hybrid vehicles to reduce the likelihood that a high charging rate will be required as the vehicle continues to operate in hybrid mode.

The fuzzy logic system has at least two input variables, the SOC and the measured drive current, and one output variable, the range extender current. Each of the input variables possess multiple, for example five, membership classes. The output variable also possesses multiple, for example five, membership functions. The fuzzy logic control algorithm was first developed with the Matlab Fuzzy logic toolbox and then transferred into the controller's language.

In each iteration of its program, the controller first evaluates the drive motor current and SOC charge. The drive motor current may be an average current over a preceding period of time. The drive motor current and SOC values are converted by dividing over their maximum possible values into a number between 0 and 1. Each value is then applied on the x-axis of its corresponding membership function. Membership in a set is considered “true” only if the resulting y-axis value is not 0. For example, if drive motor current is 0.1 it is 0.6 true for small at 0.6 and 0.4 true for small-medium. If SOC is 0.15, it is 0.4 true for low and 0.6 true for low-medium. Next, all of the rules that involve a drive motor current that is true for small or small-medium and a SOC that is true for low or low-medium are invoked. In this example, this involves four rules, two of which produce a range extender current of low and two of which produce a range extender current of medium. Next, these four rules are combined according to a combination function. In this case, the combination function involves max and min operators applied to the four rules and evaluating the center of area of the combination function. The center of area is a number between 0 and 1 that is multiple by the maximum range extender current to produce the desired range extender current. In other options, the rules may involve AND and OR statements. An activation value may be calculated for each rule, the value varying with the maximum or minimum of the degree of membership of each input value in the corresponding set used in the rule. The average of the outputs of all the rules, weighted by the activation values using a representative value for each output membership class, can be the output range extender current. Although a fuzzy logic method is preferred, the controller might also follow other control methods including, for example, mathematical operations performed on the drive motor current and state of charge values, or analysis of those values using convention boolean operators.

The control algorithm can be tuned by adjusting the membership functions, the rules applied to the input values to give the output variables, or the weighting given to the output variables to produce the combined output. In this example, the vehicle was tuned to generally sustain its SOC when the SOC is around 25%. The net range extender current (i.e. range extender current net of drive motor current) increases if the SOC drops below this level.

The control method was also tuned so that the range extender supplies current when the load on the vehicle is very high regardless of the state of charge. This behavior avoids large discharge currents being drawn from the battery. This behavior may also allow a small battery to be used, where the maximum drive motor current draw could exceed the maximum permitted discharge current of the battery. This would be particularly useful if a Li-ion battery system was used since it may materially reduce the total cost of the vehicle.

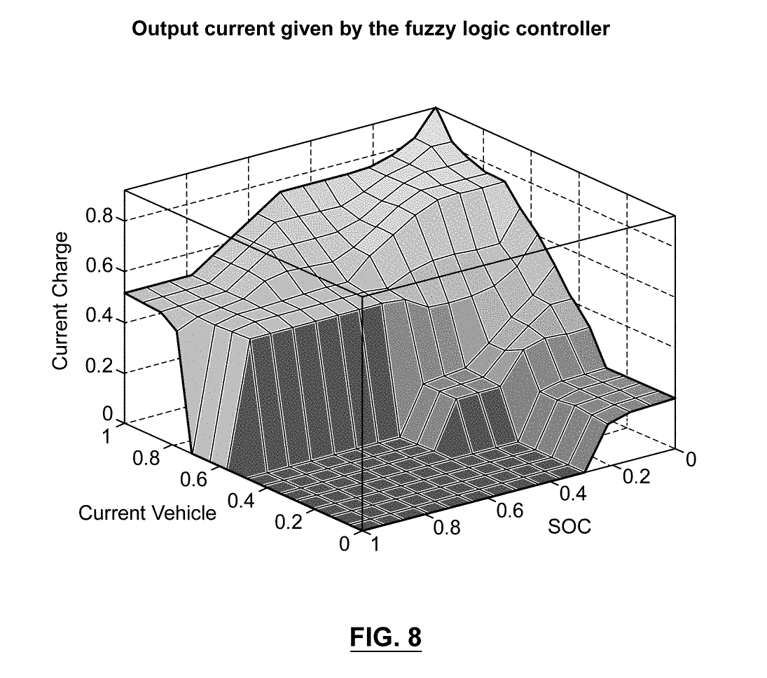

FIG. 8 shows the output current (called “currentcharge” in FIG. 8) resulting from one example of the fuzzy logic method. Other output maps are possible, and similar output maps could be obtained with other control methods. Preferably, the range extender output has one or more of three exemplary characteristics described further below. In one example, with current drawn by the drive motor (called “currentvehicle” in FIG. 8) at or below a moderate level (i.e. below a threshold such as 0.4 or 0.5) and medium to high SOC (i.e. state of charge above a threshold such as 0.4 or 0.5), the range extender does not provide power. In another example, with low SOC (i.e. SOC below a threshold such as 0.25 or 0.2), the range extender will provide at least a small current regardless of the vehicle load. However, the amount of power delivered by the range extender may generally increase with drive motor current while SOC is low. In another example, when the electric motor is drawing a significant amount of power, for example over a threshold such as 0.5 or 0.6, the range extender operates even if the battery is moderately, for example with SOC up to 0.8 or more. Optionally, with even higher vehicle load (i.e drive motor current above a threshold such as 0.8), the range extender may provide at least some power regardless of the SOC. However, the amount of power delivered by the range extender may generally increase with decreasing SOC while drive motor current is above 0.6 or 0.8.

In this discussion, values between 0 and 1 indicate a portion of the range of actual values available in the system. Optionally, any other range such as 0 to 10 can be used in the method. The values between 0 and 1 may be linearly applied to the actual variable. For example, drive current of 0.2 could be 20% of the maximum drive current that can be drawn by the drive motor, calculated in amps. If components change, for example a larger or smaller drive motor 14 used, the value of 20% of maximum drive current in amps is adjusted accordingly. Optionally, a fuzzy logic value, for example the range extender output current, may be applied to a range of possible values non-linearly, for example according to a formula or table. This can facilitate creating use or equipment cases that can be selected without changing the fuzzy logic. For example, if a vehicle will have many outdoor to indoor transitions, the 0.2 or 0.25 state of charge thresholds discussed above may be mapped to a higher state of charge, for example 50% or more. Conversely, a vehicle that is operated mostly outdoors with only short period of use indoors may have the 0.2 or 0.25 state of charge threshold mapped to a lower charge. Optionally, these adjustments could also be made by changing the fuzzy logic rules or membership functions.

Preferably, the control method is tuned such that, even if SOC charge sometimes increases, the battery discharges over time, for example to about 0.2, as the vehicle is operated according to its normal duty cycle. However, the range extender provides power selectively such that but the current flowing into or out of the battery is tempered. This helps extend the useful life of the battery, which can be a key factor in the economical operation of an industrial vehicle.

Alternatively, the output of the range extender 16 can be thought of as having four regions. At high state of charge and low drive motor current, the range extender does not provide power. At low state of charge and high drive motor current, the range extender provides high power. At low state of charge and low drive motor current, or at high state of charge and high drive motor current, the range extender provides moderate power. The precise meanings of high power and moderate power are preselected but can vary with the tuning of the control system. In some examples moderate power is between 20% and 67% of the maximum current available from the range extender and high power is above 50% of maximum current. Similarly, the precise meanings of low state of charge and high state of charge are preselected but can vary with the tuning of the control system. In some examples low charge is below 25% charge and high charge is above 50% charge. Similarly, the precise meanings of low drive motor current and high drive motor current are preselected but can vary with the tuning of the control system. In some examples high drive motor current is above 60% of maximum current and low drive motor current is below 20% of maximum current. Operating ranges not covered by this description can be allocated to one or more adjacent conditions. Areas of overlap can similarly be allocated to one or more adjacent conditions. A multitude of use cases, with corresponding drive motor current and SOC levels separating the four regions, may be predetermined and selectable by a vehicle driver or customer ordering a vehicle.

The controller 18 in this example also selects one of two available setting for actuator 46 depending on the required output current of the range extender 16. A low speed setting allows the range extender 16 to provide at least a target moderate battery charging current, for example 25 A, optionally plus a small margin. In addition to allowing the ICE 40 to operate well at this output, the inventors have observed that the reduced noise and vibration at the low speed setting improves the working conditions for the driver of the vehicle and other people nearby. The high speed setting produces more noise but, unlike the low speed setting, is able to provide the maximum output of the range extender 16. When the fuzzy logic range extender current output is 0, the ICE 40 is off. When the fuzzy logic range extender current output is above 0 and below a threshold value, the actuator 46 is set in the low speed position. When the fuzzy logic range extender current output is at or above the threshold value, the actuator 46 is set in the high speed position.

The drivetrain 10 can be modified in various ways. For example, various warning, monitoring or safety related methods or devices can be added. Although AC motors and generators are described above the powertrain could use PMAC, synchronous, DC or any other available type of components.

We claim:

1. A series hybrid powertrain, the powertrain comprising:
a battery that has a state of charge;
an electric drive motor that draws a current from the battery;
a range extender; and,
a controller that operated the range extender,
wherein the controller uses values relating to the battery state of charge and the drive motor current as inputs to determine a current to be provided by the range extender.

2. The powertrain of claim 1 wherein the controller uses a fuzzy logic based control algorithm that includes categorizing the drive motor current and state of charge into classes, wherein the degree of membership of the input values in each of multiple possible classes is determined utilizing a membership function that maps the input variable to a truth value, and a plurality of rules that use the truth values.

3. The powertrain of claim 1 wherein the controller is configured such that when the current drawn by the drive motor is below a threshold value and the state of charge is above a threshold value, the range extender does not provide power.

4. The powertrain of claim 1 wherein the controller is configured such that when the state of charge is below a threshold values, the range extender will provide a charging current regardless of the drive motor current.

5. The powertrain of claim 1 wherein the controller is configured such that when the drive motor current is above a threshold, the range extender will provide power regardless of the state of charge.

6. The powertrain of claim 1 wherein the controller determines state of charge considering the voltage of the battery.

7. The powertrain of claim 1 wherein the electric drive motor is an AC motor controllable through an associated inverter.

8. The powertrain of claim 1 wherein the range extender comprises an AC generator controllable through an associated rectifier or inverter.

9. The powertrain of claim 8 wherein the AC generator is driven by an internal combustion engine with a governor wherein the controller is able to change the target speed of the governor, optionally by selecting between a plurality of predetermined discrete settings.

10. The powertrain of claim 1 wherein the range extender is connected to a common bus with the battery and the electric drive motor.

11. A series hybrid powertrain, the powertrain comprising:
a battery that has a state of charge;
an electric drive motor that draws a current from the battery;
a range extender; and,
a controller that operates the range extender,
wherein the controller is configured to implement at least two of a) an electric only mode, b) a fuzzy logic based hybrid mode and c) a forced charge mode.

12. The powertrain of claim 11 wherein the mode is selectable by a driver of a vehicle having the powertrain.

13. The powertrain of claim 11 wherein in the electric only mode the range extender does not operate.

14. The powertrain of claim 11 wherein in the forced charge mode the range extender provides at times a current exceeding the drive motor current by a predetermined amount at least until a specified state of charge, for example at least 75%, is reached.

15. The powertrain of claim 11 wherein in forced charge mode the controller attempts to maintain a state of charge of a least a specified state of charge, for example at least 75%.

16. The powertrain of claim 11 wherein in the forced charge mode the range extender provides at times a voltage controlled output.

16. A method of operating a hybrid vehicle comprising steps of,
operating the vehicle in an electric only or hybrid mode until a battery is at least partially discharged;
operating a range extender so as to recharge the battery to at least a 75% state of charge;
thereafter maintaining at least a 75% state of charge.

17. The method of claim 16 further comprising, when the vehicle is not moving, operating a range extender to provide a balancing charge to the battery.

18. A method of operating a hybrid vehicle comprising steps of,
operating the vehicle according to a control scheme having one or more of:
a) operating the vehicle on battery power alone when the current drawn by a drive motor is below 40% and the state of charge of the battery is at least 40%;
b) providing power from a range extender when the state of charge (SOC) of the battery is below 20%; and,
c) providing power from a range extender when the current drawn by the electric motor is above 50% and SOC less than 80%.

19. The method of claim 18 comprising providing power from a range extender when the state of charge (SOC) of the battery is below 20%, wherein the amount of power delivered by the range extender is constant or increases with drive motor current while SOC is below 20%.

20. The method of claim 18 comprising providing power from a range extender when the current drawn by the electric motor is above 50% wherein the amount of power delivered by the range extender is constant or increases with decreasing SOC while drive motor current is above 50%.

21. The method of claim 18 comprising providing power from a range extender when the current drawn by the electric motor is above 80% at all battery states of charge.

22. The method of claim 18 further comprising providing at least one available reduced power or speed setting for an engine within the range extender.
